(19) United States
(12) Patent Application Publication
(10) Pub. No.: US 2019/0190971 A1
(43) Pub. Date: Jun. 20, 2019

(54) REDUCING LATENCY IN MULTICAST DELIVERY OF CONTENT

(71) Applicant: Akamai Technologies Inc., Cambridge, MA (US)

(72) Inventors: Tong Chen, Brookline, MA (US); Christian Worm Mortensen, Copenhagen (DK)

(73) Assignee: Akamai Technologies Inc., Cambridge, MA (US)

(21) Appl. No.: 16/282,666

(22) Filed: Feb. 22, 2019

(51) Int. Cl. H04L 29/06

(52) U.S. Cl. CPC H04L 65/4076; H04L 65/607; H04L 65/601

(57) ABSTRACT

This patent document describes, among other things, systems and methods for reducing the hand-waving (also known as end to end) latency in multicast delivery of content, including in particular Adaptive Bit Rate (ABR) video content and including in particular live content. The teachings hereof can facilitate, among other things, a player playing closer to the live edge.

### BACKGROUND

### Technical Field

This document relates generally to content delivery on the Internet, and more particularly to reducing latency in multicast delivery of streaming media.

### Brief Description of the Related Art

FIG. 1 illustrates an example architecture for multicast ABR delivery. In addition to the typical tiers in a traditional CDN delivery architecture, the Customer Premises Equipment (CPE) is a tier that provides the multicast handling. The CPE could be a physical component such as a home gateway, or a process running on a desktop or laptop or an app running on a mobile device.

With reference to FIG. 1, the high-level message flow looks like the following: (1) The end-user client 100 (e.g., the media player) makes an HTTP request for an media segment to the proxy content server 101. The media segment may be one of several bitrates available in an adaptive bitrate (ABR) solution. (2) The proxy content server 101 checks if the content is in a local cache 102 that it maintains. (3) If the content is in its local cache, the proxy content server 101 serves it to the client 100. (4) Otherwise, it forwards the request to the CDN content server 103, which fetches the content, possibly through the hierarchy of CDN servers (e.g., mid tier 104) and the content origin 105, and returns the response to the proxy content server 101 and client 100, (5) In the meantime, the multicast client 106 continues to receive multicast data from the multicast server 107, and from this data reconstructs the segment along with HTTP response headers and sends the reconstructed object to the local cache 102 maintained by the proxy content server 101. (6) The process repeats for the next segment(s).

Note that the components in the diagram are for illustration of the required functionalities. They might be combined into a single logical component (process or app) in actual deployment.

From the message flow described in FIG. 1, it is clear that the efficiency of multicast delivery depends on whether the content is in the local cache 102 or not when the request arrives at the proxy content server 101 from the end-user client 100. To ensure multicast efficiency, existing ABR multicast systems for HLS delivery typically hides one or more segments for the end-user client (that is, they do not show it to the client 100 on the manifest) order to give multicast client 107 enough time to receive multicast data and reconstruct the segments before the end-user client request arrives. Put another way, the system may show the end-user client player 100 only a subset of segments from the stream manifest, removing segments that are too close to the current time, or live edge. This way, the player 100 will start “farther back” in the stream. This process, however, increases the hand-waving latency (also known as end to end latency), by the total duration of the segments that are held back, relative to unicast delivery.

It would be desirable to reduce the end to end latency.

The MPEG DASH specification provides for a manifest with a media program description (MPD) that includes segment availability times, specified either in wall-clock times or timestamps. The segment availability information tell an end-user client 100 (and/or proxy content server 101) when the segments will be available to request. These times, however, are typically calibrated to be the times when the segment is available at origin 105, not accounting for delay through the multicast components. The times could be adjusted for delay and processing, such as through the multicast delivery system (i.e., the segment availability time in the cache 102 via multicast client 107). Then, a proxy content server 101 could use such a segment availability manifest to decide, when it receives a request from the end user client player 100, the segment that is available and is closest to the live edge. Of course, the segment availability information could be updated as the stream progresses, over time, by updating the manifest.

Another approach, described below in this document, avoids the need to provide a manifest with segment availability information and offers other benefits that will be explained below.

### BRIEF DESCRIPTION OF THE DRAWINGS

The invention will be more fully understood from the following detailed description taken in conjunction with the accompanying drawings, in which:

FIG. 1 is a diagram illustrating an example architecture for multicast delivery of streaming media ABR content, according to one embodiment of the teachings hereof, with fall-back top unicast;

FIG. 2 is a diagram illustrating the handling of requests with different arrival times relative to the start of a media segment;

FIG. 3 is a diagram illustrating an embodiment of a content delivery network (CDN) in which the teachings hereof may be implemented; and,

FIG. 4 is a block diagram illustrating hardware in a computer system that may be used to implement the teachings hereof.

### DETAILED DESCRIPTION

The following detailed description sets forth embodiments of the invention to provide an overall understanding of the principles of the structure, function, manufacture, and use of the methods and apparatus disclosed herein. The systems, methods and apparatus described in this application (whether in this section and in other sections) and illustrated in the accompanying drawings are non-limiting examples; the claims alone define the scope of protection that is sought. The features described or illustrated in connection with one exemplary embodiment may be combined with the features of other embodiments. Such modifications and variations are intended to be included within the scope of the present invention. All patents, patent application publications, other publications, and references listed anywhere in this document are expressly incorporated herein by reference in their entirety, and for all purposes. The term “e.g.” used throughout is used as an abbreviation for the non-limiting phrase “for example.”

The teachings hereof may be realized in a variety of systems, methods, apparatus, and non-transitory computer-readable media. It should also be noted that the allocation of functions to particular machines is not limiting, as the functions recited herein may be combined or split amongst different machines in a variety of ways.

Any description of advantages or benefits refer to potential advantages and benefits that may be obtained through practice of the teachings hereof. It is not necessary to obtain any such advantages and benefits in order to practice the teachings hereof.

Basic familiarity with well-known web page, streaming, data processing; and networking technologies and terms, such as HTML, URL, XML, AJAX, CSS, HTTP versions 1.1 and 2, DNS, HTTP over QUIC, TCP, IP, TLS, and UDP, is assumed. The term “server” is used herein to refer to actual or virtualized hardware (a computer configured as a server, also referred to as a “server machine” or “virtual server”) with software running on such hardware (e.g., a web server). In addition, the term “origin” is used to refer to an origin server. Likewise, the terms “client” and “client device” is used herein to refer to hardware in combination with software a browser or player application). While context may indicate the hardware or the software exclusively, should such distinction be appropriate, the teachings hereof can be implemented using any combination of hardware and software.

The term “media” stream or segment should be broadly construed to include reference to any form of media, whether audio, video, or otherwise, and to include multimedia presentations.

### Solution Description

The solution described in this document reduces hand-waving latency by adaptively determining what segments to include in the manifest that is served to the end user client 100 according to the arrival time of a request from the end user client 100 and a signal from the multicast server 108 to the proxy content server 101. In general, the signal provides information on the latest segment that is available or will be available in time to service the request.

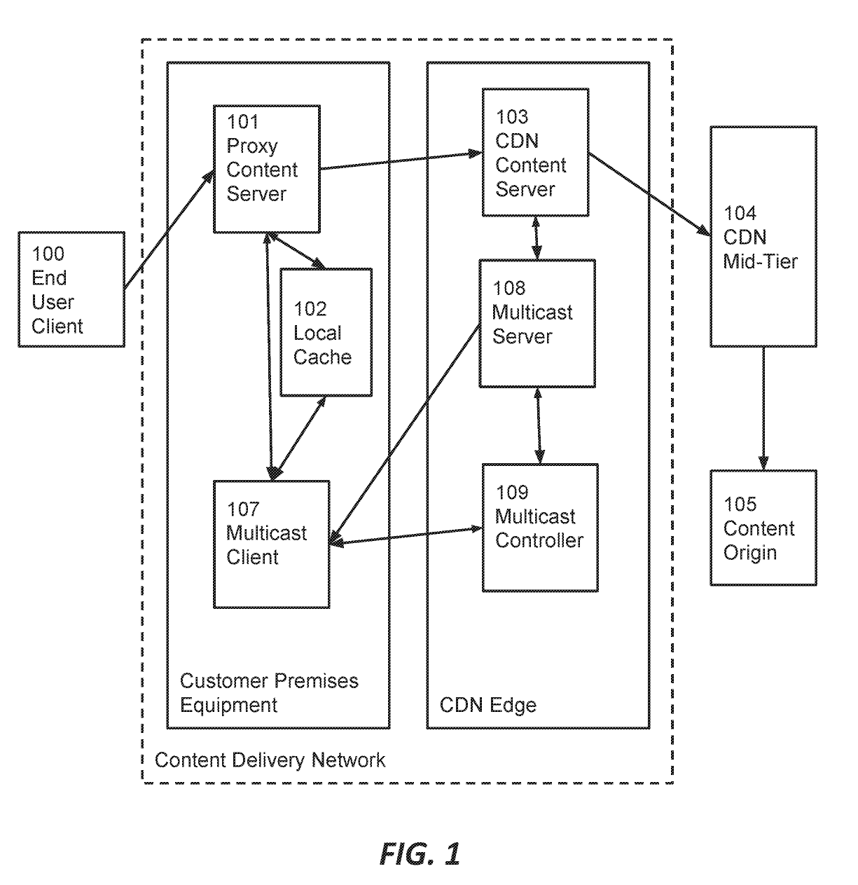

To help with the description, we use D to denote the duration of the media segments, and S to denote the multicast “turnaround time” that the time the multicast system requires to guarantee that the media segment will be delivered in time for the request. (The term “multicast system” here refers to the multicast components shown in FIG. 1.) Put another way, S is the amount of time that a segment must dwell at the multicast server 107 (before the arrival of the request) in order for the segment to be available in the local cache 102 to service the request and thereby avoid unicast fall back. Until time S for a given segment, the multicast server 107 should advertise the prior segment's sequence number.

Note that S is typically much smaller than D for situations where low-latency delivery is applicable.

The high-level flow of the solution looks like the following:
1. The multicast server 108 keeps sending the media sequence number from the manifest it received S time ago. The signal can be sent on a multicast control channel.
2. The multicast client 107 receives the media sequence number and sends it to the proxy content server 101.
3. When the proxy content server 101 receives the initial request from an end-user client 100, the proxy content server 101 compares the sequence number from multicast against the sequence number from the current manifest it fetches through unicast.
4. If the sequence numbers are the same, it suggests that the client request arrived after the multicast delivery of the segment is in progress and guaranteed to complete in time for the request. The proxy content server 101, based on that information, will serve the unmodified manifest to the end user client 100.
5. Otherwise, it suggests that the client request arrived such that the multicast delivery of the segment will not be ready in time. The proxy content server 101 will remove a number of segments from the manifest, depending on the difference of the sequence numbers, and serve the modified manifest to the end user client 100.

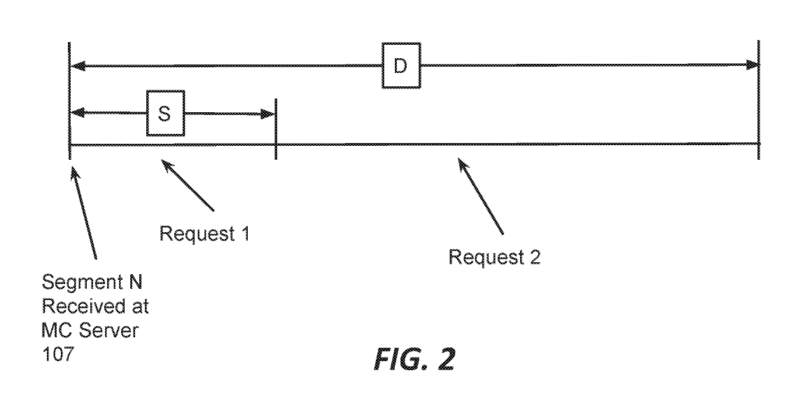

FIG. 2 illustrates the handling of requests with different arrival times relative to the receipt of a segment N at the multicast server 108. Request 1 arrived before multi cast is ready and so the end user client is served with a modified manifest with the most recent segment removed; Request 2 arrived after multicast is ready and so the end user client is served the unmodified manifest.

As can be seen from FIG. 2, once S time has elapsed at the multicast server 107, the multicast server 107 begins advertising the sequence number of the segment N. Until that time, the multicast server 107 sends the sequence number for the prior segment N−1.

Assuming the request arrival time is uniformly distributed over (0, D), the average latency with this solution can be derived as:

$$\begin{matrix}{L}_{avg} = \frac{1}{D} ( {\int }_{0}^{S} ( D + t ) dt + {\int }_{S}^{D} tdt ) \\ = \frac{1}{D} ( DS + \frac{1}{2} {S}^{2} + \frac{1}{2} {D}^{2} - \frac{1}{2} {S}^{2} ) \\ = \frac{1}{D} ( DS + \frac{1}{2} {D}^{2} ) = S + \frac{1}{2} D \\ = S + \frac{1}{2} D\end{matrix}$$

We describe above a solution to decrease the hand-waving latency in multicast delivery of content without sacrificing multicast efficiency. The general approach can be applied to different ABR formats including HLS, MPEG-DASH and CMAF. In fact, with CMAF chunked transfer encoding; the solution achieves even more improvement as S is even smaller than when no chunked transfer encoding is used.

Note that the same technique of adaptively determining what segments to advertise e.g., in a manifest) to the end user client 100 according to the arrival time of a request from the end user client 100 can also be implemented using other signals. One alternative signal is to embed a timestamp in the HTTP response header of manifest requests, with support from the origin server 105, to indicate when the manifest was last updated; or, one can use the standard Last-Modified HTTP response header. When the proxy content server 101 receives the initial request from an end-user client 100; the proxy content server 101 compares its local time against the timestamp in the header that accompanied the manifest in the HTTP response from the origin 105. The proxy content server 101 decides what manifest to serve to the end user client 100; assuming the system clocks on the origin server 105 and the end-user client 100 are synchronized. In other words, if the manifest timestamp indicates that the manifest has been recently updated, the proxy content server 101 can hide one or more segments from the manifest, because the most recent segments on the recently updated manifest will not be ready via multicast. On the other hand, if the manifest timestamp is sufficiently in the past; then the segments do not have to be hidden.

Content Delivery Networks (CDNs)

As the teachings hereof can be applied in the context of a CDN, a general overview of typical CDN components and operation is now provided.

A CDN is a distributed computer system and it can be (but does not have to be) operated and managed by a service provider. A “distributed system” of this type typically refers to a collection of autonomous computers linked by a network or networks, together with the software, systems, protocols and techniques designed to facilitate various services, such as content delivery or the support of site infrastructure. The infrastructure can be shared by multiple tenants, typically referred to as the content providers. The infrastructure is generally used for the storage, caching, or transmission of content—such as web pages, streaming media and applications—on behalf of such content providers or other tenants. The platform may also provide ancillary technologies used therewith including, without limitation, DNS query handling, provisioning, data monitoring and reporting, content targeting, personalization, and business intelligence. The CDN processes may be located at nodes that are publicly-routable on the Internet, within or adjacent to nodes that are located in mobile networks, in or adjacent to enterprise-based private networks, or in any combination thereof.

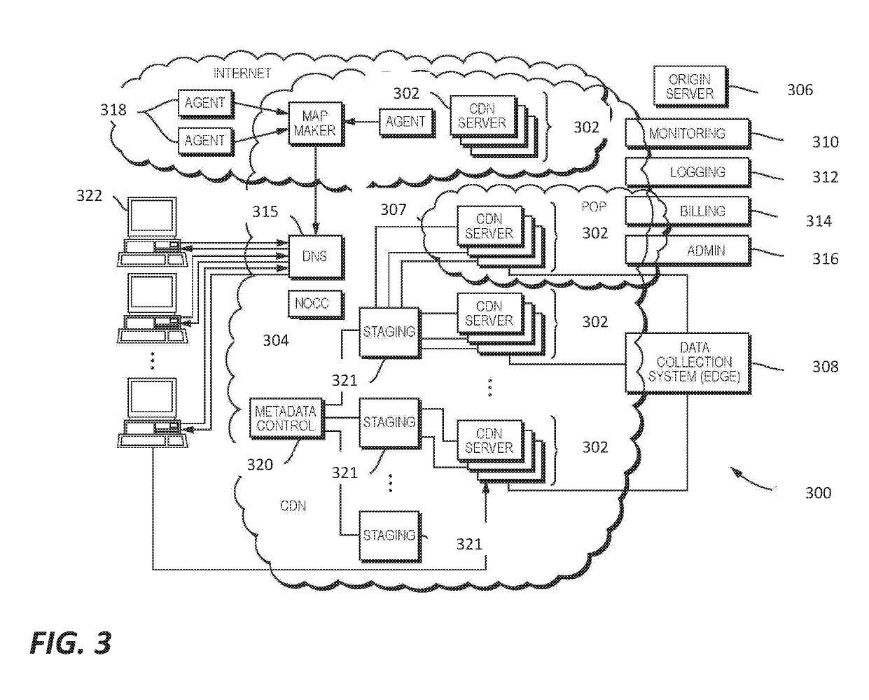

In a known system such as that shown in FIG. 3, a distributed computer system 300 is configured as a content delivery network (CDN) and is assumed to have a set of machines 302 distributed around the Internet. The machines 302 are servers and can be reverse proxy, servers. It is the machines 302, which are known as “edge servers”, that are referred to in FIG. 1 and otherwise throughout this document as the “CDN edge”, with CDN content server 103 and multicast components 107-108.

A network operations command center (NOCC) 304 may be used to administer and manage operations of the various machines in the system. Third party sites affiliated with content providers, such as web site 306, offload delivery of content (e.g., HTML or other markup language files, embedded page objects, streaming media, software downloads, and the like) to the distributed computer system 300 and, in particular, to the servers 302 (which are sometimes referred to as content servers, or sometimes as “edge” servers in light of the possibility that they are near an “edge” of the Internet). Such servers may be grouped together into a point of presence (POP) 307.

Typically, content providers offload their content delivery by aliasing (e.g., by a DNS CNAME) given content provider domains or sub-domains to domains that are managed by the service provider's authoritative domain name service. End user client machines 322 that desire such content may be directed to the distributed computer system to obtain that content more reliably and efficiently. The CDN servers respond to the client requests, for example by obtaining requested content from a local cache, from another CDN server, from the origin server 106, or other source.

Although not shown in detail in FIG. 3, the distributed computer system may also include other infrastructure, such as a distributed data collection system 308 that collects usage and other data from the CDN servers, aggregates that data across a region or set of regions, and passes that data to other back-end systems 310, 312, 314 and 316 to facilitate monitoring, logging, alerts, billing, management and other operational and administrative functions. Distributed network agents 318 monitor the network as well as the server loads and provide network, traffic and load data to a DNS query handling mechanism 315, which is authoritative for content domains being managed by the CDN. A distributed data transport mechanism 520 may be used to distribute control information (e.g., metadata to manage content; to facilitate load balancing, and the like) to the CDN servers.

A given server in the CDN comprises commodity hardware (e.g., a microprocessor) running an operating system kernel (such as Linux® or variant) that supports one or more applications. To facilitate content delivery services, for example, given machines typically run a set of applications, such as an HTTP proxy, a name server, a local monitoring process, a distributed data collection process, and the like. The HTTP proxy (sometimes referred to herein as a global host or “ghost”) typically includes a manager process for managing a cache and delivery of content from the machine. For streaming media, the machine typically includes one or more media servers, as required by the supported media formats.

A given CDN server 302 may be configured to provide one or more extended content delivery features, preferably on a domain-specific, content-provider-specific basis, preferably using configuration files that are distributed to the CDN servers using a configuration system. A given configuration file preferably is XML-based and includes a set of content handling rules and directives that facilitate one or more advanced content handling features. The configuration file may be delivered to the CDN server via the data transport mechanism, U.S. Pat. No. 7,240,100, the contents of which are hereby incorporated by reference, describe a useful infrastructure for delivering and managing CDN server content control information and this and other control information (sometimes referred to as “metadata”) can be provisioned by the CDN service provider itself, or (via an extranet or the like) the content provider customer who operates the origin server. U.S. Pat. No. 7,111,057, incorporated herein by reference, describes an architecture for purging content from the CDN.

In a typical operation, a content provider identifies a content provider domain or sub-domain that it desires to have served by the CDN. The CDN service provider associates (e.g., via a canonical name, or CNAME, or other aliasing technique) the content provider domain with a CDN hostname, and the CDN provider then provides that CDN hostname to the content provider. When a DNS query to the content provider domain or sub-domain is received at the content provider's domain name servers, those servers respond by returning the CDN hostname. That network hostname points to the CDN, and that hostname is then resolved through the CDN name service. To that end, the CDN name service returns one or more IP addresses. The requesting client application (e.g., browser) then makes a content request (e.g., via HUT or HTTPS) to a CDN server associated with the IP address. The request includes a Host header that includes the original content provider domain or sub-domain. Upon receipt of the request with the Host header, the CDN server checks its configuration file to determine whether the content domain or sub-domain requested is actually being handled by the CDN. If so, the CDN server applies its content handling rules and directives for that domain or sub-domain as specified in the configuration. These content handling rules and directives may be located within an XML-based “metadata” configuration file, as described previously. Thus, the domain name or subdomain name in the request is bound to (associated with) a particular configuration file, which contains the rules, settings, etc., that the CDN server should use for that request.

As an overlay, the CDN resources may be used to facilitate wide area network (WAN) acceleration services between enterprise data centers (which may be privately managed) and to/from third party software-as-a-service (SaaS) providers.

CDN customers may subscribe to a “behind the firewall” managed service product to accelerate Intranet web applications that are hosted behind the customer's enterprise firewall, as well as to accelerate web applications that bridge between their users behind the firewall to an application hosted in the internet cloud (e.g., from a SaaS provider). To accomplish these two use cases, CDN software may execute on machines (potentially in virtual machines running on customer hardware) hosted in one or more customer data centers, and on machines hosted in remote “branch offices.” The CDN software executing in the customer data center typically provides service configuration, service management, service reporting, remote management access, customer SSL certificate management, as well as other functions for configured web applications. The software executing in the branch offices provides last mile web acceleration for users located there. The CDN itself typically provides CDN hardware hosted in CDN data centers to provide a gateway between the nodes running behind the customer firewall and the CDN service provider's other infrastructure (e.g., network and operations facilities). This type of managed solution provides an enterprise with the opportunity to take advantage of CDN technologies with respect to their company's intranet, providing a wide-area-network optimization solution. This kind of solution extends acceleration for the enterprise to applications served anywhere on the Internet. By bridging an enterprise's CDN-based private overlay network with the existing CDN public internet overlay network, an end user at a remote branch office obtains an accelerated application end-to-end.

The CDN may have a variety of other features and adjunct components. For example the CDN may include a network storage subsystem (sometimes referred to herein as “NetStorage”) which may be located in a network datacenter accessible to the CDN servers, such as described in U.S. Pat. No. 7,472,178, the disclosure of which is incorporated herein by reference. The CDN may operate a server cache hierarchy to provide intermediate caching of customer content; one such cache hierarchy subsystem is described in U.S. Pat. No. 7,376,716, the disclosure of which is incorporated herein by reference. Communications between CDN servers and/or across the overlay may be enhanced or improved using techniques such as described in U.S. Pat. Nos. 6,820,133, 7,274,658, 7,660,296, the disclosures of which are incorporated herein by reference.

For live streaming delivery, the CDN may include a live delivery subsystem, such as described in U.S. Pat. No. 7,296,082, and U.S. Publication No. 2011/0173345, the disclosures of which are incorporated herein by reference.

Computer Based Implementation

The teachings hereof may be implemented using conventional computer systems, but modified by the teachings hereof, with the functional characteristics described above realized in special-purpose hardware, general-purpose hardware configured by software stored therein for special purposes, or a combination thereof.

Software may include one or several discrete programs. Any given function may comprise part of any given module, process, execution thread, or other such programming construct. Generalizing, each function described above may be implemented as computer code, namely, as a set of computer instructions, executable in one or more microprocessors to provide a special purpose machine. The code may be executed using an apparatus—such as a microprocessor in a computer, digital data processing device, or other computing apparatus as modified by the teachings hereof. In one embodiment, such software may be implemented in a programming language that runs in conjunction with a proxy on a standard Intel hardware platform running an operating system such as Linux. The functionality may be built into the proxy code, or it may be executed as an adjunct to that code.

While in some cases above a particular order of operations performed by certain embodiments is set forth, it should be understood that such order is exemplary and that they may be performed in a different order, combined, or the like. Moreover, some of the functions may be combined or shared in given instructions, program sequences, code portions, and the like. References in the specification to a given embodiment indicate that the embodiment described may include a particular feature, structure, or characteristic, but every embodiment may not necessarily include the particular feature, structure, or characteristic.

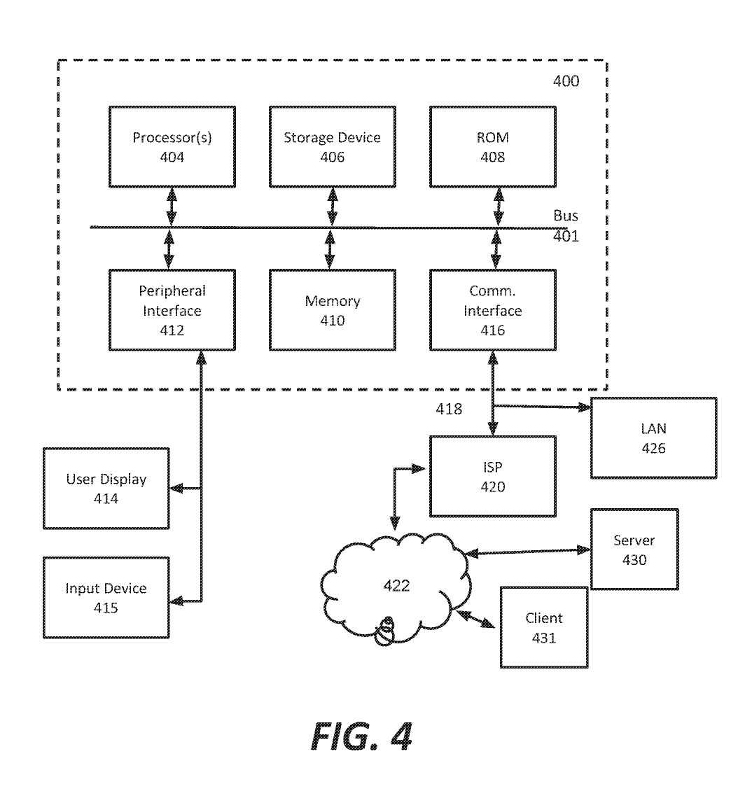

FIG. 4 is a block diagram that illustrates hardware in a computer system 400 upon which such software may run in order to implement embodiments of the invention. The computer system 400 may be embodied in a client device, server, personal computer, workstation, tablet computer, mobile or wireless device such as a smartphone, network device, router, hub, gateway, or other device. Representative machines on which the subject matter herein is provided may be Intel-processor based computers running a Linux or Linux-variant operating system and one or more applications to carry out the described functionality.

Computer system 400 includes a microprocessor 404 coupled to bus 401. In some systems, multiple processor and/or processor cores may be employed. Computer system 400 further includes a main memory 410, such as a random access memory (RAM) or other storage device, coupled to the bus 401 for storing information and instructions to be executed by processor 404. A read only memory (ROM) 408 is coupled to the bus 401 for storing information and instructions for processor 404. A non-volatile storage device 406, such as a magnetic disk, solid state memory (e.g., flash memory), or optical disk, is provided and coupled to bus 401 for storing information and instructions. Other application-specific integrated circuits (ASICs), field programmable gate arrays (FPGAs) or circuitry may be included in the computer system 400 to perform functions described herein.

A peripheral interface 412 communicatively couples computer system 400 to a user display 414 that displays the output of software executing on the computer system, and an input device 415 (e.g., a keyboard, mouse, trackpad, touchscreen) that communicates user input and instructions to the computer system 400. The peripheral interface 412 may include interface circuitry, control and/or level-shifting logic for local buses such as RS-485, Universal Serial Bus (USB), IEEE 1394, or other communication links.

Computer system 400 is coupled to a communication interface 416 that provides a link (e.g., at a physical layer, data link layer,) between the system bus 401 and an external communication link. The communication interface 416 provides a network link 418. The communication interface 416 may represent a Ethernet or other network interface card (NIC), a wireless interface, modem, an optical interface, or other kind of input/output interface.

Network link 418 provides data communication through one or more networks to other devices. Such devices include other computer systems that are part of a local area network (LAN) 426. Furthermore, the network link 418 provides a link, via an internet service provider (ISP) 420, to the Internet 422. In turn, the Internet 422 may provide a link to other computing systems such as a remote server 430 and/or a remote client 431. Network link 418 and such networks may transmit data using packet-switched, circuit-switched, or other data-transmission approaches.

In operation, the computer system 400 may implement the functionality described herein as a result of the processor executing code. Such code may be read from or stored on a non-transitory computer-readable medium, such as memory 410, ROM 408, or storage device 406. Other forms of non-transitory computer-readable media include disks, tapes, magnetic media, CD-ROMs, optical media, RAM, PROM, EPROM, and EEPROM. Any other non-transitory computer-readable medium may be employed. Executing code may also be read from network link 418 (e.g., following storage in an interface buffer, local memory, or other circuitry).

It should be understood that the foregoing has presented certain embodiments of the invention that should not be construed as limiting. For example, certain language, syntax, and instructions have been presented above for illustrative purposes, and they should not be construed as limiting. It is contemplated that those skilled in the art will recognize other possible implementations in view of this disclosure and in accordance with its scope and spirit. The appended claims define the subject matter for which protection is sought.

It is noted that trademarks appearing herein are the property of their respective owners and used for identification and descriptive purposes only, given the nature of the subject matter at issue, and not to imply endorsement or affiliation in any way.

The appended claims are part of the teachings of this document and accordingly are incorporated by reference into this description.

1. A method for determining whether a segment of a streaming media presentation will be available from a multicast delivery system to service a content request at a client device, the method comprising:
receiving from a multicast server a segment identifier, such as a sequence number, via a multicast channel to the client device;
in response to a player request for a given media stream, determining how close to the live edge of the stream the player should begin playing segments, based at least in part on the announced segment identifier.

2. The method of claim 1, wherein the multicast server announces a particular segment identifier on multicast until a time period S has elapsed, the time period S beginning after receiving the particular segment for processing, and until that point announces a previous segment identifier for a previous segment.

3. The method of claim 1, further comprising comparing the received segment identifier to a segment identifier on a manifest at the client device.

4. The method of claim 1, wherein the client device fetches segments via unicast when said segments are not available via the multicast delivery system.

5. The method of claim 1, wherein the client comprises a player and a proxy, the proxy determining whether to fetch a given segment via unicast or multicast.

6. The method of claim 1, wherein the multicast delivery system places segments received over multicast in a local cache.

7. The method of claim 1, wherein the multicast delivery system is part of a content delivery network (CDN).
